(19) United States
(12) Patent Application Publication
(10) Pub. No.: US 2024/0352302 A1
(43) Pub. Date: Oct. 24, 2024

(54) DRAG REDUCING AGENT

(71) Applicant: Dow Global Technologies LLC, Midland, MI (US)

(72) Inventors: David Koenigs, Pearland, TX (US); Larisa Mae Q. Reyes, Lake Jackson, TX (US); Edward K. Nyutu, Midland, MI (US); Daniel L. Dermody, Midland, MI (US); David L. Malotky, Midland, MI (US); Pritish M. Kamat, Pearland, TX (US); George J. Frycek, Midland, MI (US)

(21) Appl. No.: 18/685,561

(22) PCT Filed: Nov. 21, 2022
(86) PCT No.: PCT/US22/50522

§ 371 Date: Feb. 22, 2024

Related U.S. Application Data
(60) Provisional application No. 63/285,173, filed on Dec. 2, 2021.

(51) Int. Cl. C09K 8/12

(52) U.S. Cl. CPC C09K 8/12; C09K 2208/28

(57) ABSTRACT

A drag reducing agent that includes a polymer composed of one or more C₆-C₁₄ α-olefin monomers, which polymer comprises a residual amount of zirconium and has an absolute weight average molecular weight (Mw_{(Abs)}) greater than 1,300,000 g/mol and a Mw_{(Abs)}/Mn_{(Abs)} from 1.3 to 3.0, and that includes a liquid carrier that includes at least water.

### FIELD

Embodiments relate to low viscosity drag reducing agents with a liquid carrier that includes at least water and methods of making the low viscosity drag reducing agents with the liquid carrier that includes at least water.

### INTRODUCTION

When fluids are transported over long distances, such as in pipelines and conduits, substantial turbulence and wall friction may be created. These friction losses result in inefficiencies that increase equipment and operations costs. Known are drag reducing agents (DRAs) that reduce the turbulence-mediated friction and eddies, which, in turn, may decrease friction losses and pressure drop in hydrocarbon liquid pipelines. Drag reducing agents are typically ultra-high molecular weight polymers (greater than 5,000,000 g/mol) with the ability to dissolve in a hydrocarbon under turbulent flow.

Ziegler-Natta catalyst systems are used to produce conventional DRAs. However, the production of ultra-high molecular weight polymers by way of Ziegler-Natta catalysis is subject to several drawbacks. Ziegler-Natta catalysis for ultra-high molecular weight polymers is inefficient as polymerization temperatures are typically low and reaction times are long in order to produce the high molecular weight polymer needed for the application. Further, the polymer is typically broad in molecular weight distribution and final polymer properties are often difficult to control.

The art recognizes the need for drag reduction agents produced by way other than Ziegler-Natta catalysis, such as the C₆-C₁₄ olefin monomer based drag reducing agents as discussed in Publication No. WO/2021/202302. Further, it has now been found that there is a need for such drag reduction agents that are based on water, as opposed to hydrocarbon based liquid carriers, with a low viscosity and adapted for improved use in oil field applications. Exemplary applications include reducing turbulent flow or friction reduction in a pipeline or conduit, such as in midstream applications for the transport hydrocarbon fluids. Exemplary hydrocarbon fluids, in which friction loss may be reduced by the addition of the aqueous based draft reducing agent include, gas oils, diesel fuel, crude oils, fuel oils, asphaltic oils, and the like oils.

### SUMMARY

Embodiments may be realized by providing a drag reducing agent that includes a polymer composed of one or more C₆-C₁₄ α-olefin monomers, which polymer comprises a residual amount of zirconium and has an absolute weight average molecular weight (Mw_{(Abs)}) greater than 1,300,000 g/mol and a Mw_{(Abs)}/Mn_{(Abs)} from 1.3 to 3.0, and that includes a liquid carrier that includes at least water.

### DETAILED DESCRIPTION

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., 1 or 2, or 3 to 5, or 6, or 7), any subrange between any two explicit values is included (e.g., the range 1-7 above includes subranges of 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

The terms “blend” or “polymer blend,” as used herein, is a blend of two or more polymers. Such a blend may or may not be miscible (not phase separated at molecular level). Such a blend may or may not be phase separated. Such a blend may or may not contain one or more domain configurations, as determined from transmission electron spectroscopy, light scattering, x-ray scattering, and other methods known in the art.

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or” unless stated otherwise, refers to the listed members individually as well as in any combination. Use of the singular includes use of the plural and vice versa.

The term “1-hexene,” as used herein, is an unsaturated hydrocarbon α-olefin having the molecular formula C₆H₁₂ and the unsaturation is at the alpha position. 1-hexene has the molecular Structure (A) as shown below.

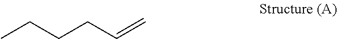

A “hexene-based polymer” is a polymer that contains more than 50 weight percent (wt %) polymerized hexene monomer (based on the total amount of polymerizable monomers) and, optionally, may contain at least one comonomer different than hexene (such as one selected from C₂₋₇ α-olefin and/or C₉₋₁₂ α-olefin). Hexene-based polymer includes hexene homopolymer, and hexene copolymer (meaning units derived from hexene and one or more comonomers). The terms “hexene-based polymer” and “polyhexene” may be used interchangeably.

The term “1-octene,” as used herein, is an unsaturated hydrocarbon α-olefin having the molecular formula C₈H₁₆ and the unsaturation is at the alpha position. 1-octene has the molecular Structure (B) as shown below.

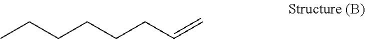

The term “isomer of octene,” as used herein, is an unsaturated hydrocarbon having the molecular formula C₈H₁₆, and the unsaturation (the double bond) is not at the alpha position. In other words, the term “isomer of octene” is any octene to the exclusion of 1-octene. Nonlimiting examples of isomers of octene include cis-2-octene, trans-2-octene, cis-3-octene, trans-3-octene, and combinations thereof as well as cis-4-octene, trans-4-octene, branched octene isomers and combinations of thereof.

An “octene-based polymer” is a polymer that contains more than 50 weight percent (wt %) polymerized octene monomer (based on the total amount of polymerizable monomers) and, optionally, may contain at least one comonomer different than octene (such as one selected from C₂₋₇ α-olefin and/or C₉₋₁₂ α-olefin). Octene-based polymer includes octene homopolymer, and octene copolymer (meaning units derived from octene and one or more comonomers). The terms “octene-based polymer” and “polyoctene” may be used interchangeably.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “octene/α-olefin polymer” are indicative of copolymer as described above prepared from polymerizing ethylene or octene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

Test Methods Gel Permeation Chromatography (GPC) The chromatographic system consisted of a PolymerChar GPC-IR (Valencia, Spain) high temperature GPC chromatograph equipped with an internal IR5 infra-red detector (IR5). The autosampler oven compartment was set at 1600 Celsius and the column compartment was set at 150° Celsius. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were dissolved at 80 degrees Celsius with gentle agitation for 30 minutes. A third-order polynomial was used to fit the respective polystyrene-equivalent calibration points.

The total plate count of the GPC column set was performed with decane (prepared at 0.04 g in 50 milliliters of TCB and dissolved for 20 minutes with gentle agitation.) The plate count (Equation 2) and symmetry (Equation 3) were measured on a 200 microliter injection according to the following equations:

$$Plate Count = 5.54 * {( \frac{( {RV}_{Peak M ax}}{Peak Width at \frac{1}{2} height} )}^{2} \qquad ( EQ2 )$$

wherein RV is the retention volume in milliliters, the peak width is in milliliters, the peak max is the maximum height of the peak, and ½ height is ½ height of the peak maximum.

$$Symmetry = \frac{( Rear Peak {RV}_{one tenth height} - {RV}_{Peak m ax} )}{( {RV}_{Peak m ax} - Front Peak {RV}_{one tenth height} )} \qquad ( EQ3 )$$

wherein RV is the retention volume in milliliters and the peak width is in milliliters, Peak max is the maximum position of the peak, one tenth height is 1/10 height of the peak maximum, and where rear peak refers to the peak tail at later retention volumes than the peak max and where front peak refers to the peak front at earlier retention volumes than the peak max. The plate count for the chromatographic system should be greater than 18,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 1600 Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polystyrene equivalent molecular weight obtained from the narrow standard calibration curve for the point (i) from Equation 1.

$${Mn}_{( GPC )} = \frac{{\sum }^{i} {IR}_{i}}{{\sum }^{i} ( \frac{{IR}_{i}}{{M}_{{polyethylene}_{i}}} )} \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 5 )$$

$$M {𝓏}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 6 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 7. Processing of the flow marker peak was done via the PolymerChar GPCOne™ Software. Acceptable flowrate correction is such that the effective flowrate should be within +/−1% of the nominal flowrate.

$$Flowrate ( effective ) = Flowrate ( nominal ) * ( RV ( F M Calibrated ) / RV ( F M Sample ) ) \qquad ( EQ7 )$$

The chromatographic system, run conditions, column set, column calibration and calculation conventional molecular weight moments and the distribution were performed according to the method described in Gel Permeation Chromatography (GPC).

For the determination of the viscometer and light scattering detector offsets from the IR5 detector, the Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn>3) to the narrow standard column calibration results from the narrow standards calibration curve using PolymerChar GPCOne™ Software.

The absolute molecular weight data was obtained in a manner consistent with that published by Zimm (Zimm, B.H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne™ software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne™) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne™) should be determined from a linear polyethylene standard with a molecular weight of about 120,000 g/mole. The viscometer calibration (determined using GPCOne™) can be accomplished using the methods described by the manufacturer, or, alternatively, by using the published values of suitable linear standards. A viscometer constant (obtained using GPCOne™) is calculated which relates specific viscosity area (DV) and injected mass for the calibration standard to its intrinsic viscosity. The chromatographic concentrations are assumed low enough to eliminate addressing 2nd viral coefficient effects (concentration effects on molecular weight).

The absolute weight average molecular weight (Mw_{(Abs)}) is obtained (using GPCOne™) from the Area of the Light Scattering (LS) integrated chromatogram (factored by the light scattering constant) divided by the mass recovered from the mass constant and the mass detector (IR5) area. The molecular weight and intrinsic viscosity responses are linearly extrapolated at chromatographic ends where signal to noise becomes low (using GPCOne™). Other respective moments, Mn_{(Abs)} and Mz_{(Abs)} are be calculated according to equations 8-9 as follows:

$${Mn}_{( A bs )} = \frac{{\sum }^{i} {IR}_{i}}{{\sum }^{i} ( \frac{{IR}_{i}}{{M}_{{Absolute}_{i}}} )} \qquad ( EQ 8 )$$

$$M {𝓏}_{( A bs )} = \frac{{\sum }^{i} ( {IR}_{i} * {M}_{{Absolute}_{i}}^{2} )}{{\sum }^{i} ( {IR}_{i} * {M}_{{Absolute}_{i}} )} \qquad ( EQ9 )$$

Residual amount of catalyst metal. A “residual amount” of catalyst metal (Ti, Hf, Zr, and Ge) is from 0 ppm, or greater than 0 ppm to less than 300 ppm, and was determined by mass balance based on added catalyst and the amount of polymer formed during reaction. Results are reported in parts per million (ppm).

Viscosity Viscosity was measured using an Anton Paar MCR102 equipped with a CC27 cylinder measuring system and a C-ETD300 heating system using a viscosity steady state method at shear rates of 0.01-100 1/second. Approximately 20 ml of sample is added to the measuring cup and then heated to 100° C. The measuring system is then lowered into the sample until it has reached 0.0 mm. This is done over a period of time, so that the force does not reach over 15 Newtons (N). Once the measuring system has reached 0.0 mm the sample along with the measuring system is held at 100° C. for 10 minutes to allow the temperature to equilibrate.

Results are reported in millipascal second (m-Pas).

Headspace Analysis of Volatile Solvent in DRA Dispersions—GC Analysis GC samples were prepared in screw top 20 mL headspace vials by addition of 1 g of DRA dispersion sample. A gas chromatography method with simultaneous flame ionization detection and mass selective detection (GC-FID-MSD) was utilized. The method uses an Agilent DB-1701 (30 m×0.32 mm×1.0 μm) employed in a 7890A Agilent GC with standard FID and an Agilent 5975C inert MSD with Triple-Axis Detector (350° C. capable). The headspace vial was equilibrated at 80° C. for 15 minutes prior to injection of 1000 μL of headspace volume. The column effluent was split between FID and MSD. Quantitation values were based on the FID chrornatograi and identification of peaks were derived from the MS spectra of component and matched to the NIST MSD library.

### Viscosity Measurement

Dispersion viscosity was measured via a Brookfield CAP 2000+parallel plate viscometer equipped with Spindle 1. Approximately 0.5 mL of dispersion is loaded into the device and subjected to 1000 rpm for 30 seconds before recording the dynamic viscosity, at approximately 25° C.

### Drag Reducing Agent

The drag reducing agent includes a polymer composed of one or more C₆-C₁₄ α-olefin monomers. The polymer includes a residual amount of zirconium, and the polymer has an absolute weight average molecular weight (Mw_{(Abs)}) greater than 1,300,000 g/mol and a Mw_{(Abs)}/Mn_{(Abs)} from 1.3 to 3.0. The polymer may account for 5 wt % to 60 wt % (e.g., 5 wt % to 55 wt %, 10 wt % to 50 wt %, 15 wt % to 30 wt %, etc.) of the draft reducing agent. The draft reducing agent further includes a liquid carrier that includes at least water. The drag reducing agent may have a viscosity from 0.1 cP (0.1 mPa·s) to 100.0 cP (100.0 mPa·s) (e.g., the viscosity may be from 0.5 cP to 50.0 cP, from 1 cP to 30 cP, from 1 cP to 15 cP, from 1 cP to 10 cP, etc.) at approximately 25° C. (e.g., as measured using the Brookfield CAP 2000+parallel plate viscometer A “drag reducing agent” (or “DRA”), as used herein, is composition that reduces the friction loss that results from the turbulent flow of a fluid. The drag reducing agent is a polymer, copolymer, or terpolymer composed of one or more C₆-C₁₄ α-olefin monomers; the polymer dispersed in, or otherwise dissolved in, the liquid carrier that includes at least water. Nonlimiting examples of suitable C₆-C₁₄ α-olefin monomers include 1-hexene, 1-heptene, 1-octene, 1-nonene, 1-decene, 1-dodecene, 1-tetradecene, and combinations thereof.

Polymer composed of one or more C₆-C₄ α-olefin monomers

The one or more C₆-C₁₄ α-olefin monomers are polymerized under polymerization conditions, in the presence of a bis-biphenylphenoxy catalyst, to form a homopolymer, a copolymer, or a terpolymer. As used herein, “polymerization conditions,” are temperature, pressure, reactant concentrations, liquid carrier selection, chain transfer agent (CTA), reactant mixing/addition parameters, and other conditions within a polymerization reactor that promote reaction between the reagents and formation of the resultant polymer product, namely homopolymer with one monomer selected from C₆-C₁₄ α-olefin, a copolymer with two monomers selected from C₆-C₁₄ α-olefin, or a terpolymer with three monomers selected from C₆-C₁₄ α-olefin. Polymerization may be conducted in a tubular reactor, in a stirred autoclave reactor, a continuous stirred tank reactor, a gas phase polymerization reactor, a slurry phase polymerization reactor, a loop reactor, an isothermal reactor, a fluidized bed gas phase reactor and combinations thereof in a batch process or a continuous process.

The one or more C₆-C₁₄ α-olefin monomers are contacted with a bis-biphenylphenoxy catalyst (or interchangeably referred to as “BBP”) under polymerization conditions. The bis-biphenylphenoxy catalyst is a metal-ligand complex with a structure as shown in Formula (I) below:

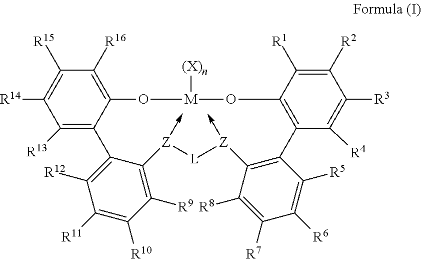

wherein
M is a metal selected from zirconium or hafnium, the metal being in a formal oxidation state of +2, +3, or +4;
n is an integer of from 0 to 3, and wherein when n is 0, X is absent; and
each X independently is a monodentate ligand that is neutral, monoanionic, or dianionic; or two Xs are taken together to form a bidentate ligand that is neutral, monoanionic, or dianionic; and X and n are chosen in such a way that the metal-ligand complex of formula (I) is, overall, neutral; and
each Z independently is O, S, N(C₁-C₄₀)hydrocarbyl, or P(C₁-C₄₀)hydrocarbyl; and
O is O (an oxygen atom);
L is (C₁-C₄₀)hydrocarbylene or (C₁-C₄₀)heterohydrocarbylene, wherein the (C₁-C₄₀)hydrocarbylene has a portion that comprises a 1-carbon atom to 10-carbon atom linker backbone linking the two Z groups in formula (I) (to which L is bonded) or the (C₁-C₄₀)heterohydrocarbylene has a portion that comprises a 1-atom to 10-atom linker backbone linking the two Z groups in formula (I), wherein each of the 1 to 10 atoms of the 1-atom to 10-atom linker backbone of the (C₁-C₄₀)heterohydrocarbylene independently is a carbon atom or heteroatom, wherein each heteroatom independently is 0, S, S(O), S(O)₂, Si(R^{C})₂, Ge(R^{C})₂, P(R^{C}), or N(R^{C}), wherein independently each R^{C} is (C₁-C₃₀)hydrocarbyl or (C₁-C₃₀) heterohydrocarbyl; and each R¹⁻¹⁶ is selected from (C₁-C₄₀)hydrocarbyl, (C₁-C₄₀)heterohydrocarbyl, Si(R^{C})₃, Ge(R^{C})₃, P(R^{C})₂, N(R^{C})₂, OR^{C}, SR^{C}, NO₂, CN, CF₃, R^{C}S(O), R^{C}S(O)₂, (R^{C})₂C═N, R^{C}C(O)O, R^{C}OC(O), R^{C}C(O)N(R), (R^{C})₂NC(O), halogen atom, hydrogen atom, and combinations thereof.

The bis-biphenylphenoxy catalyst with structure of Formula (I) may be rendered catalytically active by contacting the metal-ligand complex to, or combining the metal-ligand complex with, an activating co-catalyst.

Nonlimiting examples of suitable activating co-catalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

Nonlimiting examples of suitable Lewis acid activators (co-catalysts) include Group 13 metal compounds containing from 1 to 3 (C₁-C₂₀)hydrocarbyl substituents as described herein.

In one embodiment, Group 13 metal compounds are tri((C₁-C₂₀)hydrocarbyl)-substituted-aluminum, tri((C₁-C₂₀)hydrocarbyl)-boron compounds, tri((C₁-C₁₀)alkyl)aluminum, tri((C₆-C₁₅)aryl)boron compounds, and halogenated (including perhalogenated) derivatives thereof. In further embodiments, Group 13 metal compounds are tris(fluoro-substituted phenyl)boranes, tris(pentafluorophenyl)borane. In some embodiments, the activating co-catalyst is a tetrakis((C₁-C₂₀)hydrocarbyl borate or a tri((C₁-C₂₀)hydrocarbyl)ammonium tetrakis((C₁-C₂₀)hydrocarbyl)borate (e.g. bis(octadecyl)methylammonium tetrakis(pentafluorophenyl)borate). As used herein, the term “ammonium” means a nitrogen cation that is a ((C₁-C₂₀)hydrocarbylN(H)₃⁺, or N(H)₄⁺, wherein each (C₁-C₂₀)hydrocarbyl, when two or more are present, may be the same or different.

Nonlimiting examples of combinations of neutral Lewis acid activators (co-catalysts) include mixtures comprising a combination of a tri((C₁-C₄)alkyl)aluminum and a halogenated tri((C₆-C₁₈)aryl)boron compound, especially a tris(pentafluorophenyl)borane. Other embodiments are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex):(tris(pentafluoro-phenylborane):(alumoxane) [e.g., (Group 4 metal-ligand complex):(tris(pentafluoro-phenylborane):(alumoxane)] are from 1:1:1 to 1:10:100, in other embodiments, from 1:1:1.5 to 1:5:30.

The bis-biphenylphenoxy catalyst with structure of formula (I) may be activated to form an active catalyst composition by combination with one or more co-catalysts, for example, a cation forming co-catalyst, a strong Lewis acid, or combinations thereof. Suitable activating co-catalysts include polymeric or oligomeric aluminoxanes, especially methyl aluminoxane, as well as inert, compatible, noncoordinating, ion forming compounds. Exemplary suitable co-catalysts include, but are not limited to: modified methyl aluminoxane (MMAO), bis(hydrogenated tallow alkyl)methyl tetrakis(pentafluorophenyl)borate(1<->) amine (i.e. [HNMe(C₁₈H₃₇)₂][B(C₆F₅)₄]), and combinations of both.

One or more of the foregoing activating co-catalysts are used in combination with each other. In an embodiment, the co-catalyst is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more metal-ligand complexes of formula (I) to total number of moles of one or more of the activating co-catalysts is from 1:10,000 to 100:1. In some embodiments, the ratio is at least 1:5000, in some other embodiments, at least 1:1000; and 10:1 or less, and in some other embodiments, 1:1 or less. When an alumoxane alone is used as the activating co-catalyst, preferably the number of moles of the alumoxane that are employed is at least 100 times the number of moles of the metal-ligand complex of Formula (I). When tris(pentafluorophenyl)borane alone is used as the activating co-catalyst, in some other embodiments, the number of moles of the tris(pentafluorophenyl)borane that are employed to the total number of moles of one or more metal-ligand complexes of formula (I) from 0.5:1 to 10:1, from 1:1 to 6:1, or from 1:1 to 5:1. The remaining activating co-catalysts are generally employed in approximately mole quantities equal to the total mole quantities of one or more metal-ligand complexes of Formula (I).

In an embodiment, the bis-biphenylphenoxy catalyst with structure of formula (I) includes the metal M that is zirconium.

Polymerization includes contacting one or more C₆-C₁₄ α-olefin monomers under polymerization conditions with the bis-biphenylphenoxy catalyst of formula (I), and forming a polymer composed of one or more C₆-C₁₄ α-olefin monomers. The polymer can be a homopolymer of one monomer selected from C₆-C₁₄ α-olefin (hereafter “a C₆-C₁₄ α-olefin homopolymer”), a copolymer with two monomers selected from C₆-C₁₄ α-olefin (hereafter “a C₆-C₁₄ α-olefin copolymer”), or a terpolymer with three monomers selected from C₆-C₁₄ α-olefin (hereafter “a C₆-C₁₄ α-olefin terpolymer”). The polymer (i.e., the C₆-C₁₄ α-olefin homopolymer, the C₆-C₁₄ α-olefin copolymer, or the C₆-C₁₄ α-olefin terpolymer) contains a residual amount of zirconium or hafnium and has an absolute weight average molecular weight (Mw_{(Abs)}) greater than 1,300,000 g/mol and a Mw_{(Abs)}/Mn_{(Abs)} from 1.3 to 3.0.

The polymer (i.e., the C₆-C₁₄ α-olefin homopolymer, the C₆-C₁₄ α-olefin copolymer, or the C₆-C₁₄ α-olefin terpolymer) includes a residual amount of hafnium or zirconium, or from greater than 0 ppm to 300 ppm hafnium or zirconium.

In an embodiment, the bis-biphenylphenoxy catalyst is a metal-ligand complex having the structure Formula (II) below:

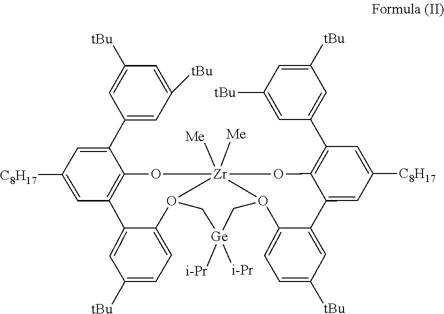

wherein Ge is germanium, Me is a methyl group, tBu is a t-butyl group, and iPr is an isopropyl group. Polymerization conditions include contacting one or more C₆-C₁₄ α-olefins under polymerization conditions with the bis-biphenylphenoxy catalyst of formula (V), and forming a polymer (i.e., a C₆-C₁₄ α-olefin homopolymer, a C₆-C₁₄ α-olefin copolymer, or a C₆-C₁₄ α-olefin terpolymer). The polymer (i.e., the C₆-C₁₄ α-olefin homopolymer, the C₆-C₁₄ α-olefin copolymer, or the C₆-C₁₄ α-olefin terpolymer) has one, some, or all of the following properties:
(i) a Mw_{(Abs)} from greater than 1,300,000 g/mol to 12,000,000 g/mol, or from 1,400,000 g/mol to 10,000,000 g/mol, or from 1,400,000 g/mol to 9,000,000 g/mol, or from 1,500,000 g/mol to 8,000,000 g/mol; and/or
(ii) a Mw_{(Abs)}/Mn_{(Abs)} from 1.3 to 3.0, or from 1.4 to 2.9, or from 1.5 to 2.8, or from 2.1 to 2.7, or from 2.2 to 2.6; and/or
(iii) a residual amount of zirconium, or from greater than 0 ppm, or 1 ppm to less than 300 ppm, or from 10 ppm to 200 ppm, or from 15 ppm to 180 ppm, or from 20 ppm to 170 ppm, or from 30 ppm to 160 ppm zirconium; and/or
(iv) a residual amount of germanium, or from greater than 0 ppm, or 1 ppm to less than 300 ppm, or from 10 ppm to 200 ppm, or from 12 ppm to 150 ppm, or from 14 ppm to 130 ppm, or from 14 ppm to 125 ppm germanium.

In an embodiment, the bis-biphenylphenoxy catalyst is a metal-ligand complex having the structure Formula (III) below:

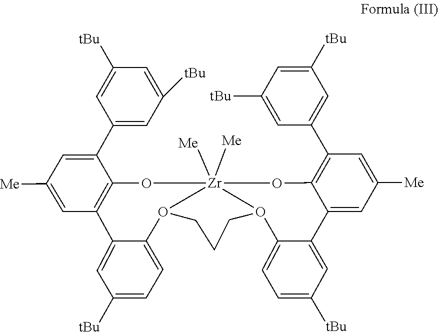

wherein Me is a methyl group, tBu is a t-butyl group. Polymerization conditions include contacting one or more C₆-C₁₄ α-olefins under polymerization conditions with the bis-biphenylphenoxy catalyst of formula (VI), and forming a polymer (i.e., a C₆-C₁₄ α-olefin homopolymer, a C₆-C₁₄ α-olefin copolymer, or a C₆-C₁₄ α-olefin terpolymer). The polymer (i.e., the C₆-C₁₄ α-olefin homopolymer, the C₆-C₁₄ α-olefin copolymer, or the C₆-C₁₄ α-olefin terpolymer) has one, some, or all of the following properties:
(i) a Mw_{(Abs)} from greater than 1,300,000 g/mol to 12,000,000 g/mol, or from 1,400,000 g/mol to 10,000,000 g/mol, or from 1,400,000 g/mol to 9,000,000 g/mol, or from 1,500,000 g/mol to 8,000,000 g/mol; and/or
(ii) a Mw_{(Abs)}/Mn_{(Abs)} from 1.3 to 3.0, or from 1.4 to 2.9, or from 1.5 to 2.8, or from 2.1 to 2.7, or from 2.2 to 2.6; and/or
(iii) a residual amount of zirconium, or from greater than 0 ppm, or 1 ppm to less than 300 ppm, or from 10 ppm to 200 ppm, or from 15 ppm to 180 ppm, or from 20 ppm to 170 ppm, or from 30 ppm to 160 ppm zirconium (hereafter Polymer1).

In an embodiment, the zirconium is present in the polymer composed of one or more C₆-C₁₄ α-olefins (Polymer1) to the exclusion of titanium. In a further embodiment, the polymer composed of one or more C₆-C₁₄ α-olefins (Polymer1) contains from 0 ppm to less than 10 ppm titanium.

In an embodiment, the C₆-C₁₄ α-olefin is octene monomer and the resultant polymer from polymerization of octene monomer with the catalyst of formula (V) is octene homopolymer. The octene homopolymer has one, some, or all of the following properties:
(i) a Mw_{(Abs)} from greater than 1,300,000 g/mol to 12,000,000 g/mol, or from 1,400,000 g/mol to 10,000,000 g/mol, or from 1,400,000 g/mol to 9,000,000 g/mol, or from 1,500,000 g/mol to 8,000,000 g/mol; and/or
(ii) a Mw_{(Abs)}/Mn_{(Abs)} from 1.3 to 3.0, or from 1.4 to 2.9, or from 1.5 to 2.8, or from 2.1 to 2.7, or from 2.2 to 2.6; and/or
(iii) a residual amount of zirconium, or from greater than 0 ppm, or 1 ppm to less than 300 ppm, or from 10 ppm to 200 ppm, or from 15 ppm to 180 ppm, or from 20 ppm to 170 ppm, or from 30 ppm to 160 ppm zirconium; and/or
(iv) a residual amount of germanium, or from greater than 0 ppm, or 1 ppm to less than 300 ppm, or from 10 ppm to 200 ppm, or from 12 ppm to 150 ppm, or from 14 ppm to 130 ppm, or from 14 ppm to 125 ppm germanium (hereafter Polymer3).

In an embodiment, the germanium and/or the zirconium is present in the octene homopolymer (Polymer3) to the exclusion of titanium. In a further embodiment, the octene homopolymer (Polymer3) contains from 0 ppm to less than 10 ppm titanium.

In an embodiment, the C₆-C₁₄ α-olefin is hexene monomer and the resultant polymer from polymerization of hexene monomer with the catalyst of formula (V) is hexene homopolymer. The hexene homopolymer has one, some, or all of the following properties:
(i) a Mw_{(Abs)} from greater than 1,300,000 g/mol to 12,000,000 g/mol, or from 1,400,000 g/mol to 10,000,000 g/mol, or from 1,400,000 g/mol to 9,000,000 g/mol, or from 1,500,000 g/mol to 8,000,000 g/mol; and/or
(ii) a Mw_{(Abs)}/Mn_{(Abs)} from 1.3 to 3.0, or from 1.4 to 2.9, or from 1.5 to 2.8, or from 2.1 to 2.7, or from 2.2 to 2.6; and/or
(iii) a residual amount of zirconium, or from greater than 1 ppm to less than 300 ppm, or from 10 ppm to 200 ppm, or from 15 ppm to 180 ppm, or from 20 ppm to 170 ppm, or from 30 ppm to 160 ppm zirconium; and/or
(iv)a residual amount of germanium, or from greater than 0 ppm, or 1 ppm to less than 300 ppm, or from 10 ppm to 200 ppm, or from 12 ppm to 150 ppm, or from 14 ppm to 130 ppm, or from 14 ppm to 125 ppm germanium (Polymer4).

In an embodiment, the germanium and/or the zirconium is present in the hexene homopolymer (Polymer4) to the exclusion of titanium. In a further embodiment, the hexene homopolymer (Polymer4) contains from 0 ppm to less than 10 ppm titanium.

### Liquid Carrier

In addition to the polymer composed of one or more C₆-C₁₄ α-olefin monomers (the polymer with Mw_{(Abs)} greater than 1,300,000 g/mol, Mw_{(Abs)}/Mn_{(Abs)} from 1.3 to 3.0 and residual amount of zirconium), the drag reducing agent also includes a liquid carrier that includes at least water. The polymer is dispersed in, or otherwise dissolved in, the liquid carrier. The liquid carrier is selected (i) to disperse the polymer as a gel, a suspension, or a slurry or (ii) dissolve the polymer.

In an exemplary embodiment, the polymer is originally prepared in a liquid carrier that is a hydrocarbon, referred to as the original hydrocarbon liquid carrier. The polymer with original hydrocarbon liquid carrier is further processed to remove at least part of the original hydrocarbon liquid carrier and add water to form an aqueous based mixture. In particular, a sufficient amount of a surfactant concentration may be added to water and then the water-surfactant mixture is added to the original polymer-hydrocarbon carrier mixture to make a bi-phasic composition. Then, the bi-phasic composition may be homogenized using a high-shear mixer in a batch or in a semi-batch reactor process, e.g., where the mixture is circulated through a homogenizer and then back to the reactor. In such a process, the hydrocarbon liquid-water azeotrope may be substantially stripped and/or removed and additional water may be added to maintain the polymer solid concentration at a desired level.

Nonlimiting examples of suitable hydrocarbons for the original hydrocarbon liquid carrier include aromatic hydrocarbons and aliphatic hydrocarbons, and combinations thereof. A nonlimiting example of a suitable aromatic hydrocarbon is toluene. In an embodiment, the original hydrocarbon liquid carrier is an aliphatic hydrocarbon. The aliphatic hydrocarbon is a linear, branched, or ringed C₄-C₁₆, or C₆-C₁₂ aliphatic hydrocarbon. For example, the original hydrocarbon liquid carrier is selected from a group consisting of liquid carrier is selected from the group consisting of a linear C₄-C₁₆ aliphatic hydrocarbon, a branched C₄-C₁₄ aliphatic hydrocarbon, a ringed C₄-C₁₆ aliphatic hydrocarbon, and combinations thereof. Nonlimiting examples of suitable aliphatic hydrocarbon solvents include butane, pentane, hexane, heptane, octane, nonane, decane, undecane, dodecane, tridecane, tetradecane, pentadecane, hexadecane, and combinations thereof.

In an embodiment, the original hydrocarbon liquid carrier is a paraffinic solvent such as Isopar™ solvents sold by Exxon-Mobil. Nonlimiting examples of suitable paraffinic solvent include Isopar™ E and Isopar™ L.

The polymer may account for 5 wt % to 60 wt % (e.g., 5 wt % to 55 wt %, 10 wt % to 50 wt %, 15 wt % to 30 wt %, etc.) of the draft reducing agent. The drag reducing agent further includes a liquid carrier that includes at least water (e.g., at least 10 wt % water, at least 20 wt % water, at least 30 wt % water, at least 40 wt % water, at least 50 wt % water, at least 60 wt % water, at least 70 wt % water, from 70 wt % to 99 wt % water, from 70 wt % to 95 wt % water, from 70 wt % to 90 wt % water, from 70 wt % to 85 wt % water, etc.) based on a total weight of the drag reducing agent.

### Surfactant

The surfactant composition may remain in the drag reducing agent, e.g., in an amount from 0.1 wt % to 20.0 wt % (e.g., 0.5 to 15.0 wt %, 1.0 wt % to 10.0 wt %, 2 wt % to 8 wt %, 4 wt % to 7 wt %, etc.) based on a total weight of the drag reducing agent. The surfactant composition may include at least one surfactant that is a secondary alcohol ethoxylate (e.g., an alcohol prepared by the reaction of a smaller chain alcohol and at least ethylene oxide).

For example, the surfactant composition may include at least one surfactant that has the following formula (1):

RO—(C₃H₆O)ₓ(C₂H₄O)_{y}—H (formula 1)
where
R is selected from the group of linear alkyl, branched alkyl, cyclic alkyl, or alkaryl group having 1 to 30 carbon atoms (e.g., 10 to 25, etc.);
x is an integer from 0 to 20 (e.g., x may be 0 to 5, 0 to 1, etc.); and
y is an integer from 1 to 50 (e.g., y may be from 10 to 50, from 30 to 50, etc.).

### Drag Reducing Agent

In an embodiment, the drag reducing agent includes:
(A) from 10 wt % to 80 wt % of the polymer composed of one or more C₆-C₁₄ α-olefin monomers (the polymer with Mw_{(Abs)} greater than 1,300,000 g/mol, Mw_{(Abs)}/Mn_{(Abs)} from 1.3 to 3.0 and residual amount of zirconium (Polymer1); and
(B) from 20 wt % to 90 wt % of the liquid carrier that includes at least water (e.g., such that any hydrocarbon liquid carrier has been substantially removed).

In an embodiment, the drag reducing agent includes
(A) from 10 wt % to 80 wt %, or from 25 wt % to 45 wt % of octene homopolymer, the octene homopolymer having one, some, or all of the following properties:
   (i) a Mw_{(Abs)} from greater than 1,300,000 g/mol to 12,000,000 g/mol, or from 1,400,000 g/mol to 10,000,000 g/mol, or from 1,400,000 g/mol to 9,000,000 g/mol, or from 1,500,000 g/mol to 8,000,000 g/mol; and/or
   (ii) a Mw_{(Abs)}/Mn_{(Abs)} from 1.3 to 3.0, or from 1.4 to 2.9, or from 1.5 to 2.8, or from 2.1 to 2.7, or from 2.2 to 2.6; and/or
   (iii) a residual amount of germanium, or from greater than 0 ppm, or 1 ppm to less than 300 ppm, or from 10 ppm to 200 ppm, or from 12 ppm to 150 ppm, or from 14 ppm to 130 ppm, or from 14 ppm to 125 ppm germanium; and/or
   (iv) a residual amount of zirconium, or from greater than 0 ppm, or 1 ppm to less than 300 ppm, or from 10 ppm to 200 ppm, or from 15 ppm to 180 ppm, or from 20 ppm to 170 ppm, or from 30 ppm to 160 ppm zirconium (Polymer3);
(B) from 20 wt % to 90 wt %, or from 75 wt % to 55 wt % liquid carrier that is includes at least water (such that any hydrocarbon liquid carrier has been substantially removed); and

In an embodiment, the drag reducing agent includes:
(A) from 10 wt % to 80 wt %, or from 25 wt % to 45 wt % of hexene homopolymer, the hexene homopolymer having one, some, or all of the following properties:
   (i) a Mw_{(Abs)} from greater than 1,300,000 g/mol to 12,000,000 g/mol, or from 1,400,000 g/mol to 10,000,000 g/mol, or from 1,400,000 g/mol to 9,000,000 g/mol, or from 1,500,000 g/mol to 8,000,000 g/mol; and/or
   (ii) a Mw_{(Abs)}/Mn_{(Abs)} from 1.3 to 3.0, or from 1.4 to 2.9, or from 1.5 to 2.8, or from 2.1 to 2.7, or from 2.2 to 2.6; and/or
   (iii) a residual amount of germanium, or from greater than 0 ppm, or 1 ppm to less than 300 ppm, or from 10 ppm to 200 ppm, or from 12 ppm to 150 ppm, or from 14 ppm to 130 ppm, or from 14 ppm to 125 ppm germanium; and/or
   (iv) a residual amount of zirconium, or from greater than 0 ppm, or 1 ppm to less than 300 ppm, or from 10 ppm to 200 ppm, or from 15 ppm to 180 ppm, or from 20 ppm to 170 ppm, or from 30 ppm to 160 ppm zirconium (Polymer4);
(B) from 20 wt % to 90 wt %, of from 75 wt % to 55 wt % liquid carrier that is an aliphatic hydrocarbon; and

### EXAMPLES

The following examples are provided to illustrate exemplary embodiments, but are not intended to limit the scope thereof. All parts and percentages are by weight unless otherwise indicated. For the examples, the preparation of the DRA includes two stages. A first stage of preparing the DRA with the original hydrocarbon liquid carrier and a second stage of removing at least part of the original hydrocarbon liquid carrier to form a DRA with a liquid carrier that includes at least water.

Preparation of Exemplary DRAs with hydrocarbon liquid carrier

The catalysts used in the comparative samples (CS) and in the inventive examples (IE) are provided in Table 1 below.

TABLE 1

| Comparative Catalyst | Inventive Catalysts |
|---|---|
| Ziegler-Natta Catalyst | Bis-biphenylphenoxy catalyst (“BBP”) |
| (ZN) | formula (V) |
| BuEtMg,MgCl₂, | BBP1 |
| Ti(OiPr)₄ | |
| 3 Ti: 40 Mg: 12 Al | 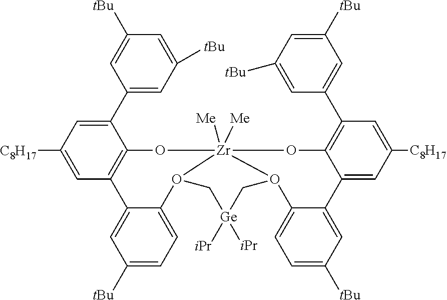 |
| | Zirconium, [[2,2′′′-[[bis[1- |
| | methylethyl)germylene]bis(methyleneoxy-.kappa.O)]bis[3″,5,5″- |
| | tris(1,1-dimethylethyl)-5′-octyl[1,1′:3′,1″-terphenyl]-2′-olato- |
| | κO]](2-)]dimethyl- |
| | CAS 958647-88-6 |
| | Bis-biphenylphenoxy catalyst BBP 2 |
| | formula (VI) |
| | 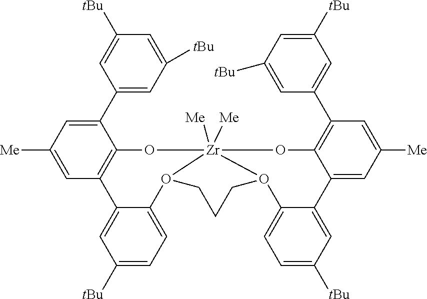 |
| | Zirconium, dimethyl[[2,2'′′-[1,3-propanediylbis(oxy- |
| | κO)]bis[3″,5,5″-tris(1,1-dimethylethyl)-5′-methyl[1,1′:3′,1″- |
| | terphenyl]-2′-olato-κO]](2-)]-, |
| | CAS 958647-88-6; CAS 1001417-33-9 |

Polymerization of 1-hexene and 1-octene: For comparative sample 1 (CS1I), polymerization is conducted with a Ziegler-Natta catalyst (ZN), in a 40 mL vial charged with 4 mL 1-octene and 8 mL solvent (Isopar E), 4 μmol catalyst (ZN), and 5 eq. of Et₃Al (as an activator), for a period of twelve hours and at a temperature of 23-25° C. Then, solvent is removed under a vacuum. CS2 is polymerized in the same manner as CS1 but the solution temperature was kept at −35° C. for a period of 48 hours during the polymerization.

For inventive examples 1-4 (IE1-4), polymerization is conducted with a bis-biphenylphenoxy catalyst (BBP1) in a 40 mL vial charged with 8 mL 1-octene and 12 mL Isopar-E (in Isopar E), 4 μmol catalyst, (BBP1) and 1.2 eq. RIBS-2 (R₂N(H)Me B(C₆F₅)₄, wherein R is hydrogenated tallowalkyl (C₁₄₋₁₈ alkyl)(CAS number 200644-82-2)as an activator), for a period of twelve hours and at a temperature of 23-25° C. Then, solvent is removed under a vacuum.

For inventive example 5 (IE5), polymerization is conducted with a bis-biphenylphenoxy catalyst (BBP2) in a 40 mL vial charged with 8 mL 1-octene and 12 mL Isopar-E (in Isopar E), 4 μmol catalyst (BBP2), and 1.2 eq. RIBS-2 (R₂N(H)Me B(C₆F₅)₄, wherein R is hydrogenated tallowalkyl (C₁₄_1s alkyl)(CAS number 200644-82-2)as an activator), for a period of twelve hours and at a temperature of 23-25° C. Then, solvent is removed under a vacuum.

For inventive example 6 (IE6), polymerization is conducted with a bis-biphenylphenoxy catalyst (BBP1) in a 40 mL vial charged with 8 mL 1-hexene and 12 mL Isopar-E, 1-4 μmol catalyst (BBP1), and 1.2 eq. RIBS-2 (R₂N(H)Me B(C₆F₅)₄, wherein R is hydrogenated tallowalkyl (C₁₄_1s alkyl)(CAS number 200644-82-2)as an activator), for a period of twelve hours and at a temperature of 23-25° C. Then, solvent and unreacted hexene isomers are removed under a vacuum.

The properties of the resulting C₆-C₅ α-olefin homopolymers are provided in Table 2 below.

TABLE 2

| | | | | | Mw | Residual | |
|---|---|---|---|---|---|---|---|
| | | | Mw (Abs) | Mn (Abs) | (Abs)/Mn | Catalyst | Residual |
| | Monomer | Catalyst | (g/mol) | (g/mol) | (Abs) | Metal¹ | Germanium¹ |
| CS1 | 1-Octene in | ZN | 1,713,128 | 205,888 | 8.32 | 22 ppm Ti | — |
| | Isopar E | | | | | | |
| CS2² | 1-Octene in | ZN | 3,489,892 | 415,619 | 8.40 | 37 ppm Ti | — |
| | Isopar E | | | | | | |
| IE1 | 1-Octene in | BBP 1 | 3,613,644 | 2,339,626 | 1.54 | 42 ppm Zr | 34 ppm Ge |
| | Isopar E | | | | | | |
| IE2 | 1-Octene in | BBP 1 | 4,560,503 | 2,507,790 | 1.82 | 20 ppm Zr | 16 ppm Ge |
| | Isopar E | | | | | | |
| IE2 | 1-Octene in | BBP 1 | 5,430,769 | 2,957,812 | 1.84 | 35 ppm Zr | 28 ppm Ge |
| | Isopar E | | | | | | |
| IE4 | 1-Octene in | BBP 1 | 6,996,782 | 3,402,438 | 2.06 | 17 ppm Zr | 14 ppm Ge |
| | Isopar E | | | | | | |
| IE5 | 1-Octene in | BBP 2 | 2,243,290 | 1,070,812 | 2.09 | 44 ppm Zr | — |
| | Isopar E | | | | | | |
| IE6 | 1-Hexene in | BBP 1 | 1,748,106 | 1,122,559 | 1.56 | 90 ppm Zr | 72 ppm Ge |
| | Isopar-E | | | | | | |

¹ppm residual catalyst metal present in homopolymer, based on the total weight of the homopolymer
²Polymerization was carried out at −35° C.

The DRA in hydrocarbon liquid carrier is shown to be an effective drag reducing agent. Drag reduction performance. Table 3 shows % drag reduction (65% theoretical maximum drag reduction) in reduction in flow loop system at various polyoctene or polyhexene dosages.

TABLE 3

| | CS 1 | CS 2 | IE 1 | IE 2 | IE 3 | IE4 | IE 5 | IE 6 |
|---|---|---|---|---|---|---|---|---|
| 10 ppm DRA | — | 11% | — | 21% | — | — | 7% | — |
| 20 ppm DRA | — | 15% | — | 26% | — | — | 10% | — |
| 50 ppm DRA | 19% | 27% | 37% | 49% | 42% | 35% | 17% | 11% |
| 100 ppm DRA | 26% | 40% | 45% | 57% | 50% | 53% | 24% | 17% |
| 200 ppm DRA | 42% | — | 57% | 66% | 62% | 65% | — | — |
| 400 ppm DRA | 47% | — | 64% | 65% | 65% | 65% | — | — |

In particular, in all cases the drag reducing agents produced using BBP catalysts (BBP1/BBP2) performed well as drag reducing agents and consistently outperformed drag reducing agents made with Ziegler-Natta catalysts. At the same molecular weight polyoctene and/or polyhexene with narrow molecular weight distribution (IE 1-6) outperformed broad molecular weight distribution and polyoctene comparative samples (CS 1-2). Though it is desired to further reduce the viscosity of the DRA to allow for broader application.

Referring to Tables 3 and 4, drag reduction for drag reducing agents is evaluated using a one meter long, 0.25 inch diameter stainless steel tubing or “test section.” The flow rate (Q) through the tubing test section is measured using a Coriolis flow meter downstream of the test section, and the pressure drop (ΔP) is measured using a differential pressure transducer across the length of the tubing test section.

The flow loop conducts the fluid between two pressure vessels or “paint pots” (PP1 and PP2). The liquid motion is generated by a pressure differential applied between the two paint pots that is set using nitrogen gas at ˜70-80 psig. The valve assembly, shown in Error! Reference source not found., is such that the fluid can be shuttled back and forth between PP1 and PP2 without requiring any line or equipment opening. Also, in both back and forth operations, the liquid travels through the test section in the same direction allowing for consistent ΔP measurements. Each paint pot is fitted with a vent valve, a pressure gauge, a pressure regulator, and a relief valve. The nitrogen gas is kept at a positive gauge pressure in both paint pots to preclude any concerns associated with flammable and combustible materials.

The full setup is placed inside a fume hood for added safety. Further, PP1 is fitted with a funnel assembly that is utilized to introduce liquids in the setup without requiring line or equipment opening.

Pressure drop across the length of the test section is measured using a wet-wet differential pressure transducer (Omega PX459-050DWUI). The transducer is connected to the pressure taps at the two ends of the test section (1 m apart) using 3/8″ diameter S.S. tubing. The pressure taps (blue crosses) are specially designed so as not to disrupt the structure of the turbulent boundary layer which is essential to obtain accurate measurements of the friction factor, key to quantifying drag reduction performance. The ⅜ inch connections to the pressure transducer are bent at 30° to the horizontal so as to prevent bubble accumulation in the lines, and to allow for easy draining of the lines via valves 3-P and 4-P. Valves 1-P and 2-P are used to degas the pressure taps after the lines are flooded for the first time (before the first run).

Flow rate of the liquid is measured using a Coriolis flow transducer (MicroMotion CMF050) that is placed downstream of the test section. A control valve is used to limit the flow rate for each run. Ideally, this setup can be used in concert with LabVIEW to accurately regulate the flow rate to a setpoint value. Opening of the control valve was manually set by the user using LabVIEW software and an automated flow control feedback loop was not utilized.

The tests are conducted in an organic liquid carrier (to mimic the hydrophobicity of crude oil). The organic liquid carrier has a lower viscosity than crude oil to be able to attain high enough flow rates (Reynolds numbers) in the test section such that flow could lie in the fully turbulent regime. As a result, Isopar L (Exxon Mobil ISOPAR™ L FLUID) was chosen as the solvent (and further mimics hydrophobicity of crude oil). Polyoctene samples synthesized in vials were premixed in Isopar L, using heat and stirring to accelerate dissolution, to prepare concentrate solutions. Drag reduction measurements were carried out at polymer concentrations ranging from 10 ppm to 400 ppm; these solutions were prepared by initially taking 2 gallons of Isopar L in the setup and adding the polymer concentrate solutions to it in increasing amounts. Drag reduction measurements were carried out for pure ISOPAR™ L FLUID (validation) and four solutions of each polyoctene.

Preparation of Exemplary DRA with Liquid Carrier that Includes Water

Firstly, a poly(1-octene) is synthesized by polymerizing 1-octene in Isopar E (Exxon Mobil ISOPAR™ E FLUID), e.g., according to the examples. All liquids are degassed with nitrogen and stored in a nitrogen filled glove box over molecular sieves. The molecular polymerization pre-catalyst, a catalysts activator and a water scavenger were added at room temperature. The polymerization is undertaken in the glove-box utilizing either glass vials or 250 mL batch glass reactor with overhead stirrer. Samples are collected periodically and characterized to track the reaction progress/1-octene conversions. After the reaction is deemed sufficiently completed and target conversions attained the reaction is terminated by addition of isopropanol. Additional diluting solvent is added in batch reactor after the polymerization of polyoctene with >15 wt % polymer solids as needed to allow for the polymer solvation/dilution and homogeneity, the mixture is mixed at 400-600 rpm at up to 100° C. (˜55° C. with hexane) for 1-6 hours.

Secondly, the polyoctene polymer in hexane from above is further treated to replace the hydrocarbon liquid carrier hexane with water. In particular, a sufficient amount of a surfactant concentration is added to water and then the water-surfactant mixture is added to the polyoctene polymer in hexane mixture to make a bi-phasic composition. Then, the bi-phasic composition is homogenized using a high-shear mixer, such that the hydrocarbon solvent carrier is removed via substantial stripping of the hydrocarbon liquid—water azeotrope, while adding additional water to maintain a sufficient concentration of the polyoctene polymer in water. Using the above discussed process, a low viscosity drag reducing agent can be produced, which drag reducing agent can also be found to be effective.

Referring to Table 4, for Inventive example 7 (IE7), 50 grams of solution of 10 wt % TERGITOL™ 15-S-40 Surfactant (available from Dow Inc.) in 90 wt % water is added to 50 grams of the 8 wt % polyoctene polymer in hexane (2.3 MM g/mol). This is followed by the homogenization of the mixture at −3000 rpm for 2-3 mins at room temperature using a Silverson Rota-stator. The mixture is further diluted with water as needed and homogenized accordingly. The hexane is removed by evaporation under vacuum using a Rotary Evaporator at 30-35° C. and 110 rpm. Periodically, additional water is added to compensate for the water stripped via the azeotropic distillation of water and hexane. To minimize frothing during vacuum stripping a drop of silicone anti-foam additive (DOWSIL™ AFE 3101) is added. Polyoctene in water mixture is produced at a 9 wt % solids content. Further, drag reduction measurement is conducted at 200 ppm for IE7, using a similar process as discussed with respect to Table 3, and IE7 is found to be effective as a drag reducing agent even at the lower viscosity and with the liquid carrier that includes water.

For Inventive example 8 (IE8), 50 grams of 10 wt % TERGITOL™ 15-S-40 Surfactant in 90 wt % water is added to 50 grams of 8 wt % polyoctene polymer in hexane (2.3 MM g/mol). Same as IE7, this is followed by the homogenization, hydrocarbon liquid-water azeotropic distillation, and further solvent exchange of the mixture. Periodically, additional water is added to compensate for the water stripped via the azeotropic distillation of water and hexane. To minimize frothing during vacuum stripping a drop of silicone anti-foam additive (DOWSIL™ AFE 3101) is added as needed. Polyoctene in water mixture is produced at 12 wt % solids content.

TABLE 4

| | |
|---|---|
| IE7 | IE8 |

Composition (wt %)

| | | |
|---|---|---|
| Polyoctene | 4.0 | 6.0 |
| Water | 90.5 | 88.0 |
| TERGITOL ™ 15-S-40 | 5.0 | 6.0 |
| Hexane (wt %) | 0.5 | <0.001 |

Properties

| Solids Content | 9 | wt % | 12 | wt % |
|---|---|---|---|---|
| MW(conventional GPC) | 2.3 | MM g/mol | 2.3 | MM g/mol |
| PDI (conventional GPC) | 2.23 | | 2.23 | |
| Viscosity at~25° C. | 2.5 | cP | 5.3 | cP |
| D₅₀, Particle Size | ≤5 | um | ≤5 | um |

| | | |
|---|---|---|
| Drag Reduction | 18% | — |

While the foregoing is directed to exemplary embodiments, other and further embodiments may be devised without departing from the basic scope thereof, and the scope thereof is determined by the claims that follow.

1. A drag reducing agent comprising:
a polymer composed of one or more C₆-C₁₄ α-olefin monomers, the polymer comprising a residual amount of zirconium, the polymer having an absolute weight average molecular weight (Mw_{(Abs)}) greater than 1,300,000 g/mol and a Mw_{(Abs)}/Mn_{(Abs)} from 1.3 to 3.0; and
a liquid carrier that includes at least water.

2. The drag reducing agent of claim 1, wherein water accounts for at least 50 wt % of a total weight of the drag reducing agent.

3. The drag reducing agent of claim 1, wherein the drag reducing agent is treated to reduce hydrocarbon liquid carrier content and increase water content.

4. The drag reducing agent of claim 1, wherein the polymer comprises from greater than 0 ppm to 300 ppm zirconium.

5. The drag reducing agent of claim 1, wherein the polymer comprises from 0 ppm to less than 10 ppm titanium and from greater than 0 ppm to 300 ppm germanium.

6. The drag reducing agent of claim 1, wherein the drag reducing agent has a viscosity from 0.1 cP to 100.0 cP at 25° C.

7. A method of reducing drag in an oil field application, the method comprising providing a hydrocarbon fluid for a pipeline or conduit and adding the drag reducing agent as claimed in claim 1 to the hydrocarbon fluid.
